(19) United States
(12) Patent Application Publication
(10) Pub. No.: US 2026/0112354 A1
(43) Pub. Date: Apr. 23, 2026

(54) METHOD AND APPARATUS FOR ADDING REVERBERATION, DEVICE, AND PRODUCT

(71) Applicant: Beijing Zitiao Network Technology Co., Ltd., Haidian District (CN)

(72) Inventors: Shichao Ge, Beijing (CN); Jin Huang, Beijing (CN)

(21) Appl. No.: 19/299,640

(22) Filed: Aug. 14, 2025

(30) Foreign Application Priority Data
Oct. 17, 2024 (CN) 202411456094.3

(51) Int. Cl. G10K 15/08; G10L 21/028; G10L 21/0308; G10L 25/06; G10L 25/18; G10L 25/21; G10L 25/27; H04R 3/04

(52) U.S. Cl. CPC G10K 15/08; G10L 21/028; G10L 21/0308; G10L 25/06; G10L 25/18; G10L 25/21; G10L 25/27; H04R 3/04

(57) ABSTRACT

The present disclosure relates to a method and an apparatus for adding reverberation, a device, and a product. The method includes: separating reverberant audio based on wet audio, where the wet audio includes dry audio and the reverberant audio corresponding to the dry audio. The method further includes: determining, based on the reverberant audio, reverberation parameters for indicating reverberation effects of the reverberant audio. In addition, the method further includes: adding reverberation to synthesized dry audio based on the reverberation parameters.

### CROSS-REFERENCE TO RELATED APPLICATION(S)

This application claims priority to Chinese Application No. 202411456094.3 filed Oct. 17, 2024, the disclosure of which is incorporated herein by reference in its entireties.

### FIELD

The present disclosure relates to the field of computers, and more particularly to a method and an apparatus for adding reverberation, a device, and a product.

### BACKGROUND

Reverberation refers to the sum of a series of gradually decaying reflected sounds formed after a plurality of reflections of a sound within an enclosed space. When a sound is emitted, the sound is continuously reflected on surfaces such as walls, ceilings, and floors. These reflected sounds are mixed with the original sound to result in reverberation effects. The reverberation effects not only can enhance the sound quality and spatial perception, but also can add specific atmospheres and emotions to the sound, while masking flaws and enhancing the sense of three-dimensionality.

To simulate such effects, professional music producers typically use hardware devices to collect reverberation data in recording studios or concert halls. In addition, other commonly used reverberation algorithms are mainly divided into two categories: impulse response (IR) algorithms and room acoustics simulation algorithms. IR algorithms simulate the reverberation characteristics in a specific space by loading pre-collected impulse response files, whereas room acoustics simulation algorithms simulate acoustic characteristics in a room by constructing a mathematical model, thereby generating the reverberation effects.

### SUMMARY

According to a first aspect of embodiments of the present disclosure, a method for adding reverberation is provided. The method includes: separating reverberant audio based on wet audio, where the wet audio includes dry audio and the reverberant audio corresponding to the dry audio. The method further includes: determining, based on the reverberant audio, reverberation parameters for indicating reverberation effects of the reverberant audio. In addition, the method further includes: adding reverberation to synthesized dry audio based on the reverberation parameters.

According to a second aspect of embodiments of the present disclosure, an apparatus for adding reverberation is provided. The apparatus includes an audio separation module configured to separate reverberant audio based on wet audio, where the wet audio includes dry audio and the reverberant audio corresponding to the dry audio. The apparatus includes a parameter determination module configured to determine, based on the reverberant audio, reverberation parameters for indicating reverberation effects of the reverberant audio. In addition, the apparatus further includes a reverberation adding module configured to add reverberation to synthesized dry audio based on the reverberation parameters.

According to a third aspect of embodiments of the present disclosure, an electronic device is provided. The electronic device includes one or more processors; and a storage apparatus configured to store one or more programs, where the one or more programs, when executed by the one or more processors, cause the one or more processors to implement a method for adding reverberation. The method includes: separating reverberant audio based on wet audio, where the wet audio includes dry audio and the reverberant audio corresponding to the dry audio. The method further includes: determining, based on the reverberant audio, reverberation parameters for indicating reverberation effects of the reverberant audio. In addition, the method further includes: adding reverberation to synthesized dry audio based on the reverberation parameters.

According to a fourth aspect of embodiments of the present disclosure, a computer program product is provided. The computer program product is tangibly stored on a non-transitory computer-readable medium and includes machine-executable instructions that, when executed, cause a machine to implement a method for adding reverberation. The method includes: separating reverberant audio based on wet audio, where the wet audio includes dry audio and the reverberant audio corresponding to the dry audio. The method further includes: determining, based on the reverberant audio, reverberation parameters for indicating reverberation effects of the reverberant audio. In addition, the method further includes: adding reverberation to synthesized dry audio based on the reverberation parameters.

The section Summary is provided to introduce a selection of concepts in a simplified form, which will be further described in the detailed description below. The section Summary is neither intended to identify key features or principal features of the claimed subject matter, nor to limit the scope of the claimed subject matter.

### BRIEF DESCRIPTION OF THE DRAWINGS

The foregoing and other features, advantages and aspects of embodiments of the present disclosure become more apparent with reference to the following detailed description and in conjunction with the accompanying drawings. Throughout the accompanying drawings, the same or similar reference numerals denote the same or similar elements, in which:

FIG. 1 is a schematic diagram of an example environment in which a plurality of embodiments of the present disclosure can be implemented;

FIG. 2 is a schematic flowchart of a method for adding reverberation according to some embodiments of the present disclosure;

FIG. 3 is a schematic diagram of an example process for adding reverberation to dry audio according to some embodiments of the present disclosure;

FIG. 4 is a schematic diagram of an example of determining reverberation parameters according to some embodiments of the present disclosure;

FIG. 5 is a block diagram of an apparatus for adding reverberation according to some embodiments of the present disclosure; and

FIG. 6 is a block diagram of a device capable of implementing a plurality of embodiments of the present disclosure.

### DETAILED DESCRIPTION OF EMBODIMENTS

It may be understood that all user-related data involved in the technical solutions should be obtained and used with the authorization of the user. It means that in the technical solutions, if personal information of the user needs to be used, explicit consent and authorization of the user are required before the data is obtained, and otherwise the collection and use of the related data will be disallowed. It should also be understood that during implementation of the technical solutions, the collection, use, and storage of data should strictly comply with relevant laws and regulations, necessary technologies and measures should be used to ensure the security of the user data and ensure safe use of the data.

It can be understood that before the use of the technical solutions disclosed in the embodiments of the present disclosure, the user shall be informed of the type, range of use, use scenarios, etc., of personal information involved in the present disclosure in an appropriate manner in accordance with the relevant laws and regulations, and the authorization of the user shall be obtained.

For example, upon reception of an active request from the user, prompt information is sent to the user to clearly inform the user that a requested operation will require access to and use of the personal information of the user. As such, the user can independently choose, based on the prompt information, whether to provide the personal information to software or hardware, such as an electronic device, an application, a server, or a storage medium, that performs operations in the technical solutions of the present disclosure.

In an alternative but non-limiting implementation, in response to the reception of the active request from the user, the prompt information may be sent to the user in the form of, for example, a pop-up window, in which the prompt information may be presented in text. Furthermore, the pop-up window may further include a selection control for the user to choose whether to “agree” or “disagree” to provide the personal information to the electronic device.

It can be understood that the above process of notifying and obtaining the authorization of the user is only illustrative and does not constitute a limitation on the implementations of the present disclosure, and other manners that satisfy the relevant laws and regulations may also be applied in the implementations of the present disclosure.

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth here. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

In the description of the embodiments of the present disclosure, the term “include” and similar terms should be understood as open-ended inclusion, namely, “including but not limited to”. The term “based on” should be understood as “at least partially based on”. The term “an embodiment” or “the embodiment” should be understood as “at least one embodiment”. The terms “first”, “second”, and the like may refer to different objects or the same object, unless otherwise explicitly defined. Other explicit and implicit definitions may be included below.

It should be understood that the technical solutions of the present disclosure are conducted with the permission of the relevant parties as permitted by laws and regulations. For example, in the field of intelligent song covering, the technical solutions are conducted when the copyright of a song being covered is obtained.

As mentioned above, reverberation can enhance texture and sense of space of a sound. To achieve an ideal reverberation effect, professional music producers usually collect reverberation data in professional recording studios. In addition, there are some algorithms for adding reverberation effects to audio. However, these algorithms are usually fixed and lack sufficient flexibility, and it is difficult to achieve specific reverberation effects for different audio. In particular, in a song covering scenario, these algorithms usually fail to provide an effective automatic parameter adjustment scheme for synthesized audio to ensure that reverberation effects of a vocal in a covered work are close to those of an original song.

Therefore, the present disclosure provides a method for adding reverberation. First, dry audio and reverberant audio corresponding to the dry audio are separated from wet audio. Then, the separated reverberant audio is analyzed to extract reverberation parameters that determine reverberation effects. Further, these extracted reverberation parameters are used to adjust reverberation settings of synthesized audio to produce synthesized audio with same reverberation effects as the original wet audio. According to the method of extracting reverberation effects from wet audio and applying the reverberation effects to synthesized dry audio, reverberation effects of the synthesized audio can be closer to those of the original wet audio, thereby improving production quality of the synthesized audio, and improving listening experience of a user.

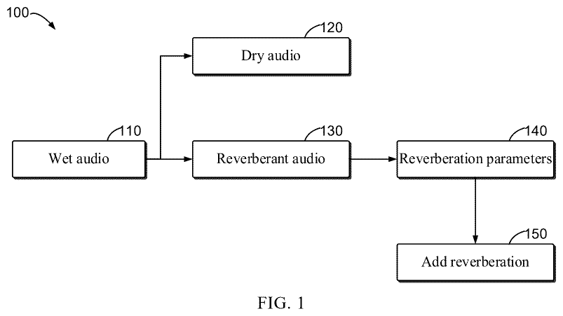

FIG. 1 is a schematic diagram of an example environment 100 in which a plurality of embodiments of the present disclosure can be implemented. As shown in FIG. 1, to ensure that the reverberation effects of the synthesized audio are close to those of the original wet audio, dry audio 120 and reverberant audio 130 corresponding to the dry audio 120 may first be separated from wet audio 110. The wet audio is a sound that has been artificially processed or added with other device effects, and compared with unprocessed dry audio, the processed wet audio typically has richer sound layers and texture. For example, the wet audio 110 here may be vocal audio with reverberation effects from a song, such that the dry audio 120 here may be dry audio of the vocal, and the reverberant audio 130 may be reverberant-effect audio of the vocal. For example, the wet audio 110 is vocal audio with reverberation effects in timbre A, the dry audio 120 is the original vocal audio in timbre A, the reverberant audio 130 is reverberant audio that is added by an engineer based on the original vocal audio in timbre A, whereas the synthesized dry audio may be dry audio in other timbre different from timbre A, for example, synthesized dry audio in timbre B. For the sake of distinction, the following description will be provided using an example where the wet audio 110 is in timbre A and the synthesized wet audio is in timbre B.

When the reverberant audio 130 (in timbre A) is separated, to make the synthesized wet audio (in timbre B) have reverberation effects comparable to those of the wet audio 110 (in timbre A), the reverberation effects of the reverberant audio 130 (in timbre A) may be analyzed to obtain reverberation parameters 140. In some embodiments, the reverberation parameters 140 may be parameters such as early reflection time, frequency cutoff points, reverberation time, and a ratio of reverberation to dry sound.

The impact of these reverberation parameters in the reverberation effects on the reverberation effects will be described one by one below. For example, the early reflection time is a time interval between a direct sound and a reflected sound first arriving at a human ear after a sound is emitted. Imagine in a large empty space, after clapping hands, sounds reflected from places such as walls and ceilings are heard. The time interval from clapping hands to hearing the first reflected sound is the early reflection time. If the early reflection time is very short, for example, in a small room, the sound sounds relatively compact and direct. If the early reflection time is relatively long, like in a large space, the sound gives people a more open and grand sense.

For another example, the reverberation time (RT60) is time required for a sound to decay by 60 dB from being emitted. When a speaker is turned on to play music in an empty room, the music sound is reflected back and forth in the room, and then gradually diminishes. If the reverberation time is very long in this room, for example, in a concert hall, the music sound lasts a long time before disappearing, giving people a grand and rich hearing experience. If the reverberation time is very short, for example, in a recording studio with a lot of sound-absorbing materials, the music sound quickly disappears, and the sound appears relatively clean and clear.

For another example, the frequency cutoff points are points at which the reverberation effects begin to weaken or disappear at different frequencies. Like a filter, a frequency range is set, and reverberation impact on a sound above or below the frequency range is reduced or disappears. For example, if the frequency cutoff points are set at relatively high frequencies, the sound in high-frequency portions may not have too many reverberation effects and may sound relatively crisp and bright. If the frequency cutoff points are set at relatively low frequencies, the sound in low-frequency portions has reduced reverberation and may be more solid and powerful.

Take the ratio of reverberation to dry sound as another example, this parameter determines the relative volume between the reverberation effects and the original dry sound. If the ratio of reverberation to dry sound is 50:50, the volumes of the reverberation effects and the dry sound are equal in the sound heard. If the ratio is adjusted to 30:70, the dry sound is more prominent, and the reverberation effects are relatively weak, such that the sound sounds relatively clear and direct. If the ratio is 70:30, the reverberation effects are more pronounced, and the sound gives people impression of being in a larger space and is relatively ethereal and spacious.

With continued reference to FIG. 1, when the reverberation parameters 140 of the wet audio 110 (in timbre A) are analyzed, reverberation may be added at 150 to make the synthesized wet audio (in timbre B) have reverberation effects consistent with those of the wet audio 110 (in timbre A). In some embodiments, the synthesized wet audio (in timbre B) may be obtained by a reverberation effect processor. For example, the synthesized dry audio (in timbre B) may be sent to the reverberation effect processor, synthesized reverberant audio (with in B) may be obtained by using the reverberation parameters 140 obtained through analysis, and then the synthesized reverberant audio (in timbre B) is mixed with the synthesized dry audio (in timbre B) to obtain the synthesized wet audio (in timbre B).

According to the method of extracting reverberation effect parameters from wet audio and applying the reverberation effects to synthesized dry audio, reverberation effects of the synthesized audio can be closer to those of the original wet audio, thereby improving production quality of the synthesized audio, and improving listening experience of a user.

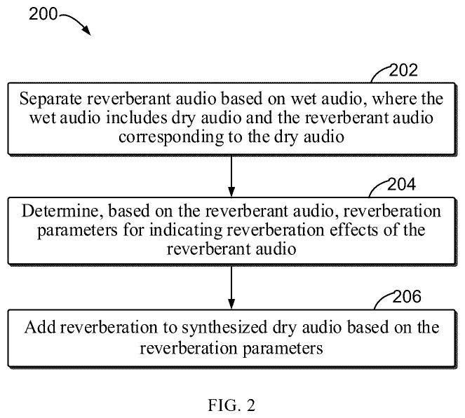

FIG. 2 is a schematic flowchart of a method 200 for adding reverberation according to some embodiments of the present disclosure. The method 200 may be performed by an apparatus for adding reverberation. The method 200 includes a block 202, a block 204, and a block 206.

As shown in FIG. 2, at the block 202, reverberant audio is separated based on wet audio, where the wet audio includes dry audio and the reverberant audio corresponding to the dry audio. Referring to FIG. 1, to ensure that the reverberation effects of the generated synthesized audio are close to those of the original wet audio, the dry audio 120 and the reverberant audio 130 corresponding to the dry audio 120 may first be separated from the wet audio 110. The wet audio is a sound that has been artificially processed or added with other device effects, and compared with unprocessed dry audio, the processed wet audio typically has richer sound layers and texture. For example, the wet audio 110 is vocal audio with reverberation effects in timbre A, the dry audio 120 is the original vocal audio in timbre A, the reverberant audio 130 is reverberant audio that is added by an engineer based on the original vocal audio in timbre A,

At the block 204, reverberation parameters for indicating reverberation effects of the reverberant audio are determined based on the reverberant audio. Referring to FIG. 1, when the reverberant audio 130 is separated, to make the synthesized wet audio have reverberation effects comparable to those of the wet audio 110 (in timbre A), the reverberation effects of the reverberant audio 130 (in timbre A) may be analyzed to obtain reverberation parameters 140. It may be understood that the synthesized wet audio here is audio in timbre different from timbre A, for example, in timbre B. In some embodiments, the reverberation parameters 140 may be parameters such as early reflection time, frequency cutoff points, reverberation time, and a ratio of reverberation to dry sound. The early reflection time is a time interval between a direct sound and a reflected sound first arriving at a human ear after a sound is emitted. The reverberation time (RT60) is time required for a sound to decay by 60 dB from being emitted. The frequency cutoff points are points at which the reverberation effects begin to weaken or disappear at different frequencies. The parameter, that is, the ratio of reverberation to dry sound, determines the relative volume between the reverberations effect and the original dry sound.

At the block 206, reverberation is added to synthesized dry audio based on the reverberation parameters. Referring to FIG. 1, when the reverberation parameters 140 of the wet audio 110 (in timbre A) are analyzed, reverberation may be added at 150 to make the synthesized wet audio (in timbre B) have reverberation effects consistent with those of the wet audio 110 (in timbre A). In some embodiments, the synthesized wet audio (in timbre B) may be obtained by a reverberation effect processor. For example, the synthesized dry audio (in timbre B) may be sent to the reverberation effect processor, synthesized reverberant audio (in timbre B) may be obtained by using the obtained reverberation parameters 140, and then the synthesized reverberant audio (in timbre B) is mixed with the synthesized dry audio (in timbre B) to obtain the synthesized wet audio (in timbre B).

According to the manner of extracting reverberation effects from wet audio and applying the reverberation effects to synthesized dry audio, reverberation effects of synthesized audio can be closer to those of the original wet audio, thereby improving production quality of the synthesized audio, and improving listening experience of a user.

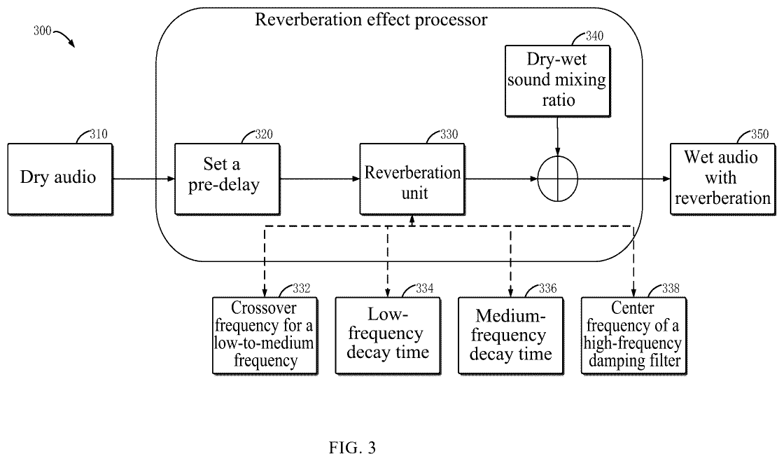

FIG. 3 is a schematic diagram of an example process 300 for adding reverberation to dry audio according to some embodiments of the present disclosure. As described above, synthesized dry audio may be sent to a reverberation effect processor, and reverberation is added to the synthesized dry audio by using reverberation parameters obtained through analysis, so that wet audio with reverberation effects can be obtained. Referring to FIG. 3, dry audio 310 may be input to a reverberation effect processor to obtain wet audio 350 with reverberation. It may be understood that, the dry audio 310 here may be synthesized dry audio or may be other types of dry audio, which is not limited in the present disclosure. For ease of illustration, however, the synthesized dry audio is used as examples.

As shown in FIG. 3, after the dry audio 310 is sent to the reverberation effect processor, a pre-delay first needs to be set at 320 to obtain appropriate early reflection time. In a real environment, a sound can not only reach a listener directly (direct sound), but also reach the listener after being reflected by obstacles such as walls and ceilings (early reflected sounds). These reflected sounds usually follow the direct sound, but there is a short delay. The pre-delay is set to simulate this time difference.

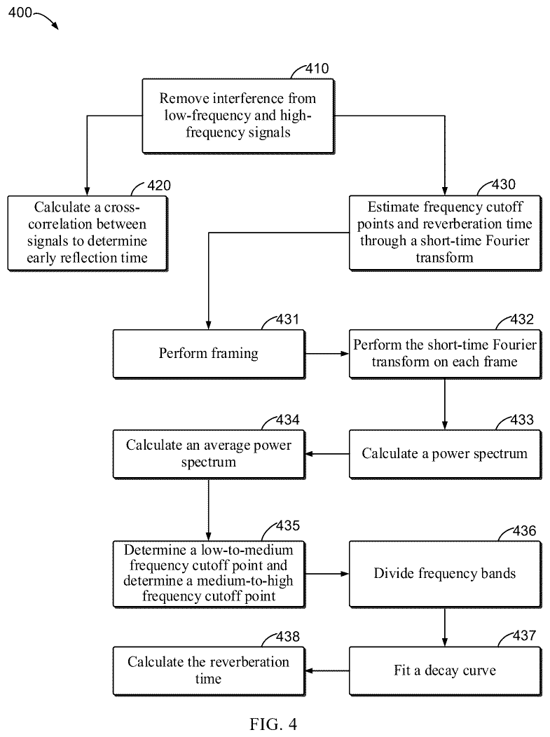

For ease of description, description is provided below with reference to FIG. 4. FIG. 4 is a schematic diagram of an example 400 of determining reverberation parameters according to some embodiments of the present disclosure. As shown in FIG. 4, for robustness, interference from low-frequency and high-frequency signals may be first removed at 410. This is because signals in high-frequency and low-frequency portions may contain noise, interference, or components unrelated to a main audio signal, and removal of these portions may make subsequent processing more accurate and reliable. In some embodiments, a signal frequency may be selectively filtered through a bandpass filter. The bandpass filter is defined as follows:

$$H ( f ) = \{ \begin{matrix}1 , if {f}_{L} \leq f \leq {f}_{H} \\ 0 , otherwise\end{matrix} \qquad ( 1 )$$

In some embodiments, a portion between 50 Hz and 12 kHz may be selected through the bandpass filter, which can improve signal quality and accuracy of subsequent processing.

In some embodiments, a signal may be selected by using a Butterworth filter. The Butterworth filter is defined as follows:

$$H ( s ) = \frac{{s}^{2 n}}{{( {s}^{2} + s \frac{{w}_{0}}{Q} + {w}_{0}^{2} )}^{n}} \qquad ( 2 )$$

Herein, s is a complex frequency variable, n is an order of the filter, w0 is a center frequency, and Q is a quality factor. The center frequency determines a center location of a passband of the filter. In the bandpass filter, the center frequency is usually located in the middle of a low-frequency cutoff frequency and a high-frequency cutoff frequency. For example, the low-frequency cutoff frequency is 50 Hz, and the high-frequency cutoff frequency is 12 kHz, and in this case, the center frequency may be around \sqrt{50×12000}.

With continued reference to FIG. 4, at 420, a cross-correlation between signals is calculated to determine early reflection time. A cross-correlation function is used to measure the cross-correlation function used to measure similarities between two signals x(t) and y(t) at different time delays. For example, if the two signals are very similar at a time delay, the two signals may have a correlation at the time delay. In some embodiments, separated dry audio may be used as reference audio, and a peak of a cross-correlation between a reference audio signal and a reverberant audio signal may be calculated. Alternatively, a peak of a cross-correlation may be calculated by directly using a plurality of signals in separated reverberant audio signals.

The cross-correlation function is defined as follows in a continuous form:

$${R}_{xt} ( τ ) {\int }_{- ∞}^{∞} x ( t ) \cdot y ( t + τ ) dt \qquad ( 3 )$$

(τ) Is a time delay. An integral result reflects a similarity between two signals at the time delay. If an integral value is relatively large, it indicates that the two signals are more similar at the time delay. If the integral value is relatively small, it indicates that the two signals are less similar at the time delay.

The cross-correlation function may be represented as follows in a discrete form:

$${R}_{xt} ( k ) {\int }_{n = 0}^{N - 1} [ x ] \cdot y [ n + k ] dt \qquad ( 4 )$$

A time delay between signals can be estimated by finding a maximum location value of the cross-correlation. To simulate an early reflection in a complex environment, a maximum value of the cross-correlation and a value with a distance of more than 20 ms from the maximum value may be selected. This is because in an actual acoustic environment, the early reflection is usually not just a single time delay, but consists of a plurality of reflections. Selecting the value with a distance of more than 20 ms from the maximum value may capture more early reflection components, thereby more accurately simulating reverberation effects in the complex environment.

In some embodiments, to prevent occurrence of divergence that does not satisfy an actual situation, an early reflection value may be constrained within [0.02, 0.1] seconds. This is because in an actual acoustic environment, the early reflection usually occurs in a relatively short time range. If the early reflection value is unconstrained, an unreasonable time delay value may occur, resulting in an unrealistic simulation of reverberation effects. Constraining the time delay within a reasonable range can ensure that a simulated early reflection satisfies an actual situation, thereby improving authenticity and credibility of reverberation effects.

Returning to FIG. 3, when an early reflection parameter is obtained to set the pre-delay and an early reflection signal is obtained, the obtained early reflection signal may be input to a reverberation unit 330 to obtain reverberant audio. In the reverberation unit, setting reverberation parameters is crucial for obtaining reverberant audio with good reverberation effects. Generally, reverberation parameters such as reverberation time and a frequency cutoff point need to be set. A crossover frequency 332 for a low-to-medium frequency and a center frequency 338 of a high-frequency damping filter are correlated with the frequency cutoff point, while low-frequency decay time 334 and medium-frequency decay time 336 correspond to the reverberation time.

Referring to FIG. 4, after the interference from the low-frequency and high-frequency signals is removed, the frequency cutoff point and the reverberation time (RT60) may be estimated through a short-time Fourier transform at 430. Given that an audio signal is a complex signal that varies over time, and much information may be lost when the audio signal is directly analyzed in a time domain or a frequency domain, the audio signal is usually analyzed in two dimensions: the time domain and the frequency domain. At 431, framing is performed to segment the audio signal into small time segments (frames), and then a Fourier transform (STFT) is performed on each segment at 432, so that a frequency component within each time segment can be obtained, and the audio signal is analyzed in the time domain and the frequency domain.

In some embodiments, a calculation formula for framing STFT is as follows:

$$S T F {T}_{x ( t )} ( m , k ) = {\sum }_{n = - ∞}^{∞} x [ n ] \cdot w [ n - m ] \cdot {e}^{- j 2 π k n / N} \qquad ( 5 )$$

w[n] is a window function. A part of the signal can be intercepted in each time frame, so that there is an overlap between adjacent time frames, thereby reducing a boundary effect brought by framing, and better reflecting a local characteristic of the audio signal in time. Formula (5) represents performing the Fourier transform on a result obtained after an original audio signal x[n] and a window function w[n−m] are multiplied. Specifically, for each time frame m and a frequency index k, an original signal is now shifted in time by m sample points, and then is multiplied by the window function, and the Fourier transform is further performed on a product. In the Fourier transform, e^{-j2πkn/N} is a complex exponential function, where N is a quantity of points in an FFT and determines frequency resolution. Alternatively, the window function may alternatively be a window function such as a Hanning window or a Hamming window.

Framing STFT calculation segments an audio signal into time frames, and then performs the Fourier transform on each frame, to implement time domain analysis of the audio signal, and provides a basis for further processing and analyzing the audio signal.

With continued reference to FIG. 4, in signal processing, power is usually correlated with energy of a signal. To determine energy distribution of the signal in different time frames and at different frequencies, a power spectrum may be calculated at 433. If a value of the power spectrum is relatively high in a time frame and at a frequency, the energy of the signal is relatively high at the time and the frequency. In some embodiments, a squared modulus of each time frame may be calculated to obtain the power spectrum, which is as follows:

$$P ( m , k ) = {\vert {STFT}_{x ( t )} ( m , k ) \vert}^{2} \qquad ( 6 )$$

Herein, the obtained P(m, k) is the power spectrum, which represents power of the signal in an m^{th} time frame and at a k^{th} frequency. Because the modulo operation results in an amplitude value of a complex number, phase information is not taken into account here.

With continued reference to FIG. 4, to obtain a more stable estimation for the power spectrum, power spectra in a plurality of time periods may be averaged, so that an average power spectrum can be calculated at 434. In this way, an overall energy level of the signal at each frequency can be seen. As shown in Formula (6), a manner of calculating the average power spectrum is as follows:

$$mean\_spectrum ( f ) = 1 / T {\sum }_{t = 1}^{T} S ( f , t ) \qquad ( 7 )$$

S(f, t) represents a power spectrum value at a frequency f and time t, and T is a total quantity of time frames.

With continued reference to FIG. 4, when the average power spectrum is obtained, segmentation points of different frequency ranges may be determined based on peaks in the average power spectrum. Because generally, the peaks represent frequency locations with relatively high energy, and these locations correspond to transition points of different frequency ranges. A low-to-medium frequency cutoff point and a medium-to-high frequency cutoff point may be determined at 435. In some embodiments, the average power spectrum mean_spectrum may be used as a delimiting condition, and a peak greater than the energy can be considered as a possible frequency segmentation point, which can avoid an error leading to an inaccurate segmentation point.

In some embodiments, a low-to-medium frequency segmentation point is usually selected at 500 Hz, while a medium-to-high frequency segmentation point may be selected around 8000 Hz. It may be understood that the frequency segmentation point here may be flexibly adjusted based on reverberation effects. In some embodiments, a cutoff frequency may be constrained within a reasonable range for robustness. For example, a low-to-medium frequency range may be constrained within [100, 900], while a medium-to-high frequency may be constrained within [1800, 10000]. In some embodiments, if the determined frequency segmentation point is not within these ranges, the frequency segmentation point may be adjusted to be within the ranges, which can ensure that the frequency range obtained through division is proper and stable. This avoids unreasonable frequency band division due to individual outliers or inaccurate segmentation points, which affects determining of reverberation parameters at a next stage.

With continued reference to FIG. 4, when the frequency segmentation points, that is, the frequency cutoff points, are determined, frequency ranges may be divided based on these frequency segmentation points, so that frequency bands can be divided at 436. Through this process of dynamically determining a frequency band step-by-step, reasonable division of different frequency ranges of a reverberant audio signal can be achieved.

With continued reference to FIG. 4, when the frequency bands are divided, a decay curve may be fitted at 437. Before the decay curve is fitted, to determine overall signal levels in different frequency ranges (i.e., different frequency bands) of the reverberant audio signal, it is also necessary to calculate a power spectrum in each frequency band based on the dynamically divided frequency bands.

$$\overline{P} ( m , band ) = \frac{1}{{K}_{band}} {\sum }_{k ϵ band} P ( m , k ) \qquad ( 8 )$$

P̅(m, band) represents an average power spectrum in a particular frequency band in an m^{th} time frame, K_{band} is a quantity of frequencies within each adaptive frequency band, and P(m, k) represents a power spectral density in the m^{th} time frame and at a k^{th} frequency.

In some embodiments, after average power spectra in a low-to-medium frequency band and a medium-to-high frequency band are obtained, to make a change trend of data more intuitive and make it easy to process, a logarithm of P̅(m, band) may be calculated to fit the decay curve, that is:

$$log ( \overline{P} ( m , band ) ) = a \cdot m + b \qquad ( 9 )$$

Herein, m is an index of framing, and represents a discrete representation of time; and a and b are coefficients obtained through fitting by using a least squares method. By fitting this decay curve for power spectra in different frequency bands, reverberation characteristics of a sound in different frequency ranges can be better understood. For example, the slope of decay a may reflect the decay rate of a sound within different frequency bands, which is crucial for analyzing the propagation and reflection characteristics of reverberant audio signals in different environments.

With continued reference to FIG. 4, after the fitted decay curve is obtained, the reverberation time may be calculated at 438. In some embodiments, a formula for calculating the reverberation time (RT60) is as follows:

$$RT 60 ( band ) = - 60 / ( a \cdot Δ t ) \qquad ( 10 )$$

RT60(band) represents the reverberation time in a particular frequency band; a is a coefficient obtained in fitting of the decay curve, and in units of dB/frame; and Δt is a time length corresponding to each frame. With the calculation formula (10), the reverberation time can be accurately calculated based on the known parameters Δt (and) a, thereby better controlling reverberation effects of synthesized audio.

Returning to FIG. 3, after obtaining, based on the reverberation parameters, the reverberant audio corresponding to the dry audio 310, the reverberation unit 330 may determine, based on a dry-wet sound mixing ratio 340, how dry audio and wet audio are mixed. In some embodiments, the dry-wet sound mixing ratio may be determined by using a regression model. For example, the dry-wet sound mixing ratio may be determined by using a linear regression model in a scikit-learn library. For example, input of the regression model is characteristics (dry sound energy, reverberation energy, and a dry-wet ratio), and output is an optimal dry-wet reverberation ratio. For example, in conjunction with FIG. 1, energy of the dry audio 120 and energy of the reverberant audio 130 that are separated from the wet audio 110 and a dry-wet ratio there between may be input to the regression model, so that an optimal dry-wet reverberation ratio can be obtained. Appropriate reverberant audio can be added to synthesized dry audio based on the dry-wet reverberation ratio predicted through the model, so that wet audio with reverberation can be obtained at 350.

According to the method of automatically adding reverberation in the present disclosure, complexity of manually adjusting reverberation parameters can be avoided, and reverberation can be added to bulk synthesized dry audio, thereby saving resources. In addition, according to the method of extracting reverberation effects from wet audio and applying the reverberation effects to synthesized dry audio, reverberation effects of the synthesized audio can be closer to those of the original wet audio, thereby improving production quality of the synthesized audio, and improving listening experience of a user.

In some embodiments, the regression model may be trained based on the following method:

For each song in a collected training set (i.e., wet audio), energy of dry audio of a vocal and energy of a reverberant signal may be calculated by using Formula (11).

$${\sum }_{n = 1}^{N} {\vert x [ n ] \vert}^{2} \qquad ( 11 )$$

x[n] is a sample value of a signal, and N is a total quantity of samples. When the energy of the dry audio and the energy of the reverberant signal are obtained, an energy ratio between dry and wet signals can be obtained.

In some embodiments, extracted features (energy of a dry signal, energy of a reverberation signal, and an energy ratio between dry and wet signals) may form a dataset together with a corresponding target reverberation ratio. The target reverberation ratio is a subjective score obtained through hearing test of a professional audio engineer. For example, when listening to a song, the audio engineer gives a ratio value indicating a suitability degree of reverberation effects based on professional experience and hearing experience. This ratio value reflects whether reverberation effects of the song are ideal in current dry sound and reverberation settings.

In some embodiments, the dataset may be divided into a training set and a test set by using a function in the scikit-learn library. For example, a ratio of the test set may be to 0.2, which means that 20% of data is randomly selected as the test set and the remaining data is used as the training set. The purpose of this division is to be able to independently evaluate performance of the model while training the model.

In some embodiments, a linear regression model may be selected for training. For an input feature matrix (including features such as dry sound energy, reverberation energy, and a dry-wet ratio) and a target dry-wet ratio, parameters of the model are adjusted by minimizing an error between a predicted value and a true value, allowing the model to predict the target reverberation ratio as accurately as possible.

In some embodiments, after training is completed, the regression model is used to predict the test set to obtain a predicted dry-wet reverberation ratio. Then, a mean squared error (mean_squred_error) is used to evaluate performance of the model. The mean squared error is an average value of squares of differences between predicted values and true values, and can measure prediction accuracy of the model.

According to the method of extracting reverberation effects from wet audio and applying the reverberation effects to synthesized dry audio, reverberation effects of the synthesized audio can be closer to those of the original wet audio, thereby improving production quality of the synthesized audio, and improving listening experience of a

FIG. 5 is a block diagram of an apparatus 500 for adding reverberation according to some embodiments of the present disclosure. As shown in FIG. 5, the apparatus 500 includes an audio separation module 502 configured to separate reverberant audio based on wet audio, where the wet audio includes dry audio and the reverberant audio corresponding to the dry audio. The apparatus 500 includes a parameter determination module 504 configured to determine, based on the reverberant audio, reverberation parameters for indicating reverberation effects of the reverberant audio. In addition, the apparatus 500 further includes a reverberation adding module 506 configured to add reverberation to synthesized dry audio based on the reverberation parameters.

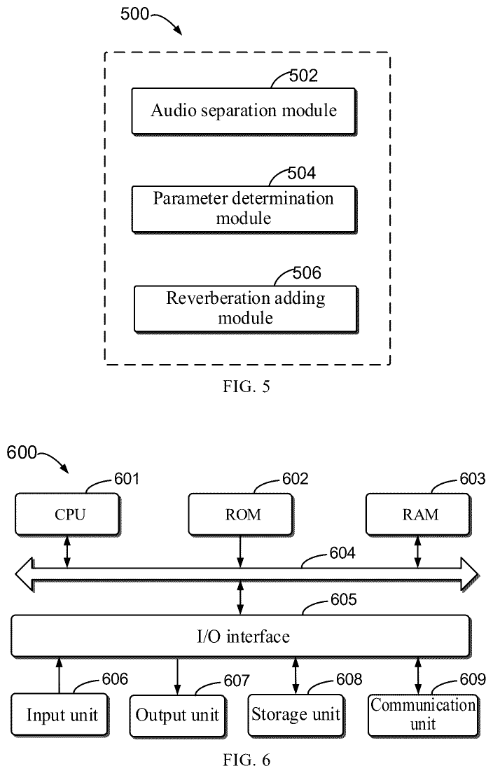

FIG. 6 is a block diagram of a device 600 capable of implementing a plurality of embodiments of the present disclosure. As shown in FIG. 6, the device 600 includes a central processing unit (CPU) and/or graphics processing unit (GPU) 601 that may perform a variety of appropriate actions and processing in accordance with computer program instructions stored in a read-only memory (ROM) 602 or computer program instructions loaded from a storage unit 608 into a random-access memory (RAM) 603. The RAM 603 may further store various programs and data required for the operation of the device 600. The CPU/GPU 601, the ROM 602, and the RAM 603 are connected to each other via a bus 604. An input/output (I/O) interface 605 is also connected to the bus 604. Although not shown in FIG. 6, the device 600 may further include a coprocessor.

A number of components in the device 600 are connected to the I/O interface 605, including: an input unit 606, such as a keyboard or a mouse; an output unit 607, such as various types of displays or speakers; the storage unit 608, such as a magnetic disk or an optical disk; and a communication unit 609, such as a network card, a modem, or a wireless communication transceiver. The communication unit 609 allows the device 600 to exchange information/data with other devices over a computer network such as the Internet and/or various telecommunication networks.

Each method or process described above may be performed by the CPU/GPU 601. For example, in some embodiments, the method may be implemented as a computer software program tangibly embodied in a machine-readable medium, such as the storage unit 608. In some embodiments, some or all of the computer programs may be loaded into and/or installed onto the device 600 via the ROM 602 and/or the communication unit 609. When the computer program is loaded into the RAM 603 and executed by the CPU/GPU 601, one or more steps or actions in the method or process described above may be performed.

In some embodiments, the methods and processes described above may be implemented as a computer program product. The computer program product may include a computer-readable storage medium on which computer-readable program instructions for performing various aspects of the present disclosure are carried.

The computer-readable storage medium may be a tangible device that can hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples of the computer-readable storage medium (a non-exhaustive list) include: a portable computer disk, a hard disk, a random-access memory (RAM), a read-only memory (ROM), an erasable programmable read-only memory (EPROM) (or a flash memory), a static random-access memory (SRAM), a portable compact disk read-only memory (CD-ROM), a digital versatile disk (DVD), a memory stick, a floppy disk, a mechanical coding device, a punched card or an in-groove raised structure on which instructions are for example stored, and any suitable combination thereof. The computer-readable storage medium used here is not to be interpreted as a transient signal, such as a radio wave or another freely propagating electromagnetic wave, an electromagnetic wave propagating through a waveguide or another transmission medium (e.g., an optical pulse through a fiber-optic cable), or an electrical signal transmitted over a wire.

The computer-readable program instructions described here may be downloaded from a computer-readable storage medium to each computing/processing device, or downloaded to an external computer or an external storage device over a network, such as the Internet, a local area network, a wide area network, and/or a wireless network. The network may include copper transmission cables, fiber-optic transmission, wireless transmission, routers, firewalls, switches, gateway computers, and/or edge servers. A network adapter card or network interface in each computing/processing device receives computer-readable program instructions from the network and forwards the computer-readable program instructions for storage in the computer-readable storage medium in each computing/processing device.

The computer program instructions for performing the operations of the present disclosure may be assembly instructions, Instruction Set Architecture (ISA) instructions, machine instructions, machine-related instructions, microcode, firmware instructions, status setting data, or source code or object code written in any combination of one or more programming languages, including object-oriented programming languages as well as conventional procedural programming languages. The computer-readable program instructions may be completely executed on a computer of a user, partially executed on a computer of a user, executed as an independent software package, partially executed on a computer of a user and partially executed on a remote computer, or completely executed on a remote computer or server. In a case of the remote computer, the remote computer may be connected to the computer of the user through any kind of network, including a local area network (LAN) or a wide area network (WAN), or may be connected to an external computer (for example, connected through the Internet with the aid of an Internet service provider). In some embodiments, an electronic circuit, such as a programmable logic circuit, a field programmable gate array (FPGA), or a programmable logic array (PLA), is personalized by using state information of the computer-readable program instructions. The electronic circuit may execute the computer-readable program instructions to implement various aspects of the present disclosure.

These computer-readable program instructions may be provided to a processing unit of a general-purpose computer, a special-purpose computer, or another programmable data processing apparatus to produce a machine, such that the instructions, when executed by the processing unit of the computer or the other programmable data processing apparatus, create an apparatus for implementing functions/actions specified in one or more blocks in the flowchart and/or the block diagrams. These computer-readable program instructions may alternatively be stored in the computer-readable storage medium. These instructions enable a computer, a programmable data processing apparatus, and/or another device to work in a specific manner. Therefore, the computer-readable medium storing the instructions includes an artifact that includes instructions for implementing various aspects of functions/actions specified in one or more blocks in the flowchart and/or the block diagrams.

Alternatively, the computer-readable program instructions may be loaded onto a computer, another programmable data processing apparatus, or another device, such that a series of operation steps are performed on the computer, the other programmable data processing apparatus, or the other device to produce a computer-implemented process. Therefore, the instructions executed on the computer, the other programmable data processing apparatus, or the other device implement functions/actions specified in one or more blocks in the flowchart and/or the block diagrams.

The flowcharts and the block diagrams in the accompanying drawings illustrate possible system architectures, functions, and operations of the device, the method, and the computer program product according to a plurality of embodiments of the present disclosure. In this regard, each block in the flowcharts or the block diagrams may represent a part of a module, a program segment, or an instruction. The part of the module, the program segment, or the instruction includes one or more executable instructions for implementing a specified logical function. In some alternative implementations, functions tokenized in the blocks may occur in a sequence different from that tokenized in the accompanying drawings. For example, two consecutive blocks may actually be executed substantially in parallel, or may sometimes be executed in a reverse order, depending on a function involved. It should also be noted that each block in the block diagrams and/or the flowcharts, and a combination of the blocks in the block diagrams and/or the flowcharts may be implemented by a dedicated hardware-based system that executes specified functions or actions, or may be implemented by a combination of dedicated hardware and computer instructions.

Various embodiments of the present disclosure have been described above. The foregoing descriptions are exemplary, not exhaustive, and are not limited to the disclosed embodiments. Many modifications and variations are apparent to a person of ordinary skill in the art without departing from the scope and spirit of the described embodiments. The terminology used in this specification is intended to best explain the principles, practical applications, or technical improvements in the market of the embodiments, or to enable others of ordinary skill in the art to understand the embodiments disclosed here.

Some example implementations of the present disclosure are listed below.

Example 1. A method for adding reverberation, comprising:
separating reverberant audio based on wet audio, the wet audio comprising dry audio
and the reverberant audio corresponding to the dry audio;
determining, based on the reverberant audio, reverberation parameters for indicating reverberation effects of the reverberant audio; and
adding reverberation to synthesized dry audio based on the reverberation parameters.

Example 2. The method according to Example 1, where the determining, based on the reverberant audio, reverberation parameters for indicating reverberation effects of the reverberant audio comprises:
determining early reflection time based on the reverberant audio, the early reflection time indicating a time interval between a direct sound and a reflected sound first arriving at a human ear after a sound is emitted;
determining frequency cutoff points based on the reverberant audio, the frequency cutoff points comprising a low-to-medium frequency cutoff point and a medium-to-high frequency cutoff point; and
determining reverberation time based on the reverberant audio, where the reverberation time indicates time required for a sound to decay by a predetermined decibel level from being emitted; and
determining, by a regression model, a ratio of reverberation to dry sound based on the dry audio and the reverberant audio.

Example 3. The method according to either of Examples 1 and 2, where the determining early reflection time based on the reverberant audio comprises:
determining a peak of a cross-correlation between the reverberant audio and reference audio; and
determining the early reflection time based on the peak of the cross-correlation.

Example 4. The method according to any one of Examples 1 to 3, where the determining frequency cutoff points based on the reverberant audio comprises:
determining the frequency cutoff points based on the reverberant audio through a short-time Fourier transform.

Example 5. The method according to any one of Examples 1 to 4, where the determining the frequency cutoff points based on the reverberant audio through a short-time Fourier transform comprises:
segmenting, based on time windows, the reverberant audio into a plurality of reverberant audio segments corresponding to the time windows; and
performing the short-time Fourier transform on each of the reverberant audio segments corresponding to the time windows to obtain a time-frequency domain representation of each frame of a reverberant audio segment corresponding to each of the time windows; and
determining, for the time-frequency domain representation of each frame, a squared modulus of a time-frequency domain representation of each time frame to obtain a power spectrum of the time frame.

Example 6. The method according to any one of Examples 1 to 5, further comprising:
averaging power spectra of all time frames in a frequency dimension to obtain an average power spectrum;
determining the low-to-medium frequency cutoff point based on a first predetermined delimiting condition and a peak of the average power spectrum; and
determining the medium-to-high frequency cutoff point based on a second predetermined delimiting condition and the peak of the average power spectrum.

Example 7. The method according to any one of Examples 1 to 6, further comprising:
in response to determining the low-to-medium frequency cutoff point and the medium-to-high frequency cutoff point, determining, for each time frame, an average value of power spectra in a plurality of frequency ranges determined by the low-to-medium frequency cutoff point and the medium-to-high frequency cutoff point.

Example 8. The method according to any one of Examples 1 to 7, where the determining reverberation time based on the reverberant audio comprises:
determining a logarithm of the average value of the power spectra in the plurality of frequency ranges and fitting a curve to obtain a decay curve; and
determining the reverberation time based on the decay curve.

Example 9. The method according to any one of Examples 1 to 8, where the determining, by a regression model, a ratio of reverberation to dry sound based on the dry audio and the reverberant audio comprises:
training the regression model based on training audio, the training audio comprising training dry audio and training reverberant audio corresponding to the training dry audio.

Example 10. The method according to any one of Examples 1 to 9, where the training the regression model based on training audio comprises:
determining energy of the training dry audio and energy of the training reverberant audio separately;
determining a ratio of the energy of the training dry audio to the energy of the training reverberant audio;
training the regression model based on a target ratio and the determined ratio; and
adjusting parameters of the regression model based on a mean squared error.

Example 11. The method according to any one of Examples 1 to 10, where the adding reverberation to synthesized dry audio based on the reverberation parameters comprises:
generating synthesized reverberant audio based on the reverberation parameters; and
adding the reverberation to the synthesized dry audio based on the ratio of reverberation to dry sound, the synthesized reverberant audio, and the synthesized dry audio.

Example 12. The method according to any one of Examples 1 to 10, further comprising:
removing predetermined high-frequency and low-frequency portions of the reverberant audio through a bandpass filter.

Example 13. An apparatus for adding reverberation, comprising:
an audio separation module configured to separate reverberant audio based on wet audio, the wet audio comprising dry audio and the reverberant audio corresponding to the dry audio;
a parameter determination module configured to determine, based on the reverberant audio, reverberation parameters for indicating reverberation effects of the reverberant audio; and
a reverberation adding module configured to add reverberation to synthesized dry audio based on the reverberation parameters.

Example 14. The apparatus according to Example 13, where the parameter determination module comprises:
a first determination module configured to determine early reflection time based on the reverberant audio, the early reflection time indicating a time interval between a direct sound and a reflected sound first arriving at a human ear after a sound is emitted;
a second determination module configured to determine frequency cutoff points based on the reverberant audio, the frequency cutoff points comprising a low-to-medium frequency cutoff point and a medium-to-high frequency cutoff point; and
a third determination module configured to determine reverberation time based on the reverberant audio, where the reverberation time indicates time required for a sound to decay by a predetermined decibel level from being emitted; and
a fourth determination module configured to determine, by a regression model, a ratio of reverberation to dry sound based on the dry audio and the reverberant audio.

Example 15. The apparatus according to either of Examples 13 and 14, where the first determination module comprises:
a fifth determination module configured to determine a peak of a cross-correlation between the reverberant audio and reference audio; and
a sixth determination module configured to determine the early reflection time based on the peak of the cross-correlation.

Example 16. The apparatus according to any one of Examples 13 to 15, where the second determination module comprises:
a seventh determination module configured to determine the frequency cutoff points based on the reverberant audio through a short-time Fourier transform.

Example 17. The apparatus according to any one of Examples 13 to 16, where the seventh determination module comprises:
a first segmentation module configured to segment, based on time windows, the reverberant audio into a plurality of reverberant audio segments corresponding to the time windows; and
a transform module configured to perform the short-time Fourier transform on each of the reverberant audio segments corresponding to the time windows to obtain a time-frequency domain representation of each frame of a reverberant audio segment corresponding to each of the time windows; and
an eighth determination module configured to determine, for the time-frequency domain representation of each frame, a squared modulus of a time-frequency domain representation of each time frame to obtain a power spectrum of the time frame.

Example 18. The apparatus according to any one of Examples 13 to 17, further comprising:
a first averaging module configured to average power spectra of all time frames in a frequency dimension to obtain an average power spectrum;
a ninth determination module configured to determine the low-to-medium frequency cutoff point based on a first predetermined delimiting condition and a peak of the average power spectrum; and
a tenth determination module configured to determine the medium-to-high frequency cutoff point based on a second predetermined delimiting condition and the peak of the average power spectrum.

Example 19. The apparatus according to any one of Examples 13 to 18, further comprising:
an eleventh determination module configured to: in response to determining the low-to-medium frequency cutoff point and the medium-to-high frequency cutoff point, determine, for each time frame, an average value of power spectra in a plurality of frequency ranges determined by the low-to-medium frequency cutoff point and the medium-to-high frequency cutoff point.

Example 20. The apparatus according to any one of Examples 13 to 19, where the third determination module comprises:
a twelfth determination module configured to determine a logarithm of the average value of the power spectra in the plurality of frequency ranges and fit a curve to obtain a decay curve; and
a thirteenth determination module configured to determine the reverberation time based on the decay curve.

Example 21. The apparatus according to any one of Examples 13 to 20, where the fourth determination module comprises:
a first training module configured to train the regression model based on training audio, the training audio comprising training dry audio and training reverberant audio corresponding to the training dry audio.

Example 22. The apparatus according to any one of Examples 13 to 21, where the first training module comprises:
a fourteenth determination module configured to determine energy of the training dry audio and energy of the training reverberant audio separately;
a fifteenth determination module configured to determine a ratio of the energy of the training dry audio to the energy of the training reverberant audio;
a second training module configured to train the regression model based on a target ratio and the determined ratio; and
an adjustment module configured to adjust parameters of the regression model based on a mean squared error.

Example 23. The apparatus according to any one of Examples 13 to 22, where the reverberation adding module comprises:
a generation module configured to generate synthesized reverberant audio based on the reverberation parameters; and
an adding module configured to add the reverberation to the synthesized dry audio based on the ratio of reverberation to dry sound, the synthesized reverberant audio, and the synthesized dry audio.

Example 24. The apparatus according to any one of Examples 13 to 23, further comprising:
a removal module configured to remove predetermined high-frequency and low-frequency portions of the reverberant audio through a bandpass filter.

Example 25. An electronic device, comprising:
a processor; and
a memory coupled to the processor, where the memory has stored therein instructions that, when executed by the processor, cause the electronic device to perform actions comprising:
separating reverberant audio based on wet audio, the wet audio comprising dry audio and the reverberant audio corresponding to the dry audio;
determining, based on the reverberant audio, reverberation parameters for indicating reverberation effects of the reverberant audio; and
adding reverberation to synthesized dry audio based on the reverberation parameters.

Example 26. The electronic device according to Example 25, where the determining, based on the reverberant audio, reverberation parameters for indicating reverberation effects of the reverberant audio comprises:
determining early reflection time based on the reverberant audio, the early reflection time indicating a time interval between a direct sound and a reflected sound first arriving a human ear after a sound is emitted;
determining frequency cutoff points based on the reverberant audio, the frequency cutoff points comprising a low-to-medium frequency cutoff point and a medium-to-high frequency cutoff point; and
determining reverberation time based on the reverberant audio, where the reverberation time indicates time required for a sound to decay by a predetermined decibel level from being emitted; and
determining, by a regression model, a ratio of reverberation to dry sound based on the dry audio and the reverberant audio.

Example 27. The electronic device according to either of Examples 25 and 26, where the determining early reflection time based on the reverberant audio comprises:
determining a peak of a cross-correlation between the reverberant audio and reference audio; and
determining the early reflection time based on the peak of the cross-correlation.

Example 28. The electronic device according to any one of Examples 25 to 27, where the determining frequency cutoff points based on the reverberant audio comprises:
determining the frequency cutoff points based on the reverberant audio through a short-time Fourier transform.

Example 29. The electronic device according to any one of Examples 25 to 28, where the determining the frequency cutoff points based on the reverberant audio through a short-time Fourier transform comprises:
segmenting, based on time windows, the reverberant audio into a plurality of reverberant audio segments corresponding to the time windows; and
performing the short-time Fourier transform on each of the reverberant audio segments corresponding to the time windows to obtain a time-frequency domain representation of each frame of a reverberant audio segment corresponding to each of the time windows; and
determining, for the time-frequency domain representation of each frame, a squared modulus of a time-frequency domain representation of each time frame to obtain a power spectrum of the time frame.

Example 30. The electronic device according to any one of Examples 25 to 29, further comprising:
averaging power spectra of all time frames in a frequency dimension to obtain an average power spectrum;
determining the low-to-medium frequency cutoff point based on a first predetermined delimiting condition and a peak of the average power spectrum; and
determining the medium-to-high frequency cutoff point based on a second predetermined delimiting condition and the peak of the average power spectrum.

Example 31. The electronic device according to any one of Examples 25 to 30, further comprising:
in response to determining the low-to-medium frequency cutoff point and the medium-to-high frequency cutoff point, determining, for each time frame, an average value of power spectra in a plurality of frequency ranges determined by the low-to-medium frequency cutoff point and the medium-to-high frequency cutoff point.

Example 32. The electronic device according to any one of Examples 25 to 31, where the determining reverberation time based on the reverberant audio comprises:
determining a logarithm of the average value of the power spectra in the plurality of frequency ranges and fitting a curve to obtain a decay curve; and
determining the reverberation time based on the decay curve.

Example 33. The electronic device according to any one of Examples 25 to 32, where the determining, by a regression model, a ratio of reverberation to dry sound based on the dry audio and the reverberant audio comprises:
training the regression model based on training audio, the training audio comprising training dry audio and training reverberant audio corresponding to the training dry audio.

Example 34. The electronic device according to any one of Examples 25 to 33, where the training the regression model based on training audio comprises:
determining energy of the training dry audio and energy of the training reverberant audio separately;
determining a ratio of the energy of the training dry audio to the energy of the training reverberant audio;
training the regression model based on a target ratio and the determined ratio; and
adjusting parameters of the regression model based on a mean squared error.

Example 35. The electronic device according to any one of Examples 25 to 34, where the adding reverberation to synthesized dry audio based on the reverberation parameters comprises:
generating synthesized reverberant audio based on the reverberation parameters; and
adding the reverberation to the synthesized dry audio based on the ratio of reverberation to dry sound, the synthesized reverberant audio, and the synthesized dry audio.

Example 36. The electronic device according to any one of Examples 25 to 35, further comprising:
removing predetermined high-frequency and low-frequency portions of the reverberant audio through a bandpass filter.

Example 37. A computer-readable storage medium having stored thereon computer-executable instructions that, when executed by a processor, cause the method according to any one of Examples 1 to 12 to be implemented.

Example 38. A computer program product tangibly stored on a computer-readable medium and comprising computer-executable instructions that, when executed by a device, cause the device to perform the method according to any one of Examples 1 to 12. Although the present disclosure has been described in a language specific to structural features and/or logical actions of the method, it should be understood that the subject matter defined in the appended claims is not necessarily limited to the specific features or actions described above. In contrast, the specific features and actions described above are merely exemplary forms of implementing the claims.

I/We claim:

1. A method for adding reverberation, comprising:
separating reverberant audio based on wet audio, the wet audio comprising dry audio and the reverberant audio corresponding to the dry audio;
determining, based on the reverberant audio, reverberation parameters for indicating reverberation effects of the reverberant audio; and
adding reverberation to synthesized dry audio based on the reverberation parameters.

2. The method according to claim 1, wherein the determining, based on the reverberant audio, reverberation parameters for indicating reverberation effects of the reverberant audio comprises:
determining early reflection time based on the reverberant audio, the early reflection time indicating a time interval between a direct sound and a reflected sound first arriving at a human ear after a sound is emitted;
determining frequency cutoff points based on the reverberant audio, the frequency cutoff points comprising a low-to-medium frequency cutoff point and a medium-to-high frequency cutoff point; and
determining reverberation time based on the reverberant audio, wherein the reverberation time indicates time required for a sound to decay by a predetermined decibel level from being emitted; and
determining, by a regression model, a ratio of reverberation to dry sound based on the dry audio and the reverberant audio.

3. The method according to claim 2, wherein the determining early reflection time based on the reverberant audio comprises:
determining a peak of cross-correlation between the reverberant audio and reference audio; and
determining the early reflection time based on the peak of cross-correlation.

4. The method according to claim 2, wherein the determining frequency cutoff points based on the reverberant audio comprises:
determining the frequency cutoff points based on the reverberant audio through a short-time Fourier transform.

5. The method according to claim 4, wherein the determining the frequency cutoff points based on the reverberant audio through a short-time Fourier transform comprises:
segmenting, based on time windows, the reverberant audio into a plurality of reverberant audio segments corresponding to the time windows; and
performing the short-time Fourier transform on each of the reverberant audio segments corresponding to the time windows to obtain a time-frequency domain representation of each frame of a reverberant audio segment corresponding to each of the time windows; and
determining, for the time-frequency domain representation of each frame, a squared modulus of a time-frequency domain representation of each time frame to obtain a power spectrum of the time frame.

6. The method according to claim 5, further comprising:
averaging power spectra of a plurality of time frames in a frequency dimension to obtain an average power spectrum;
determining the low-to-medium frequency cutoff point based on a first predetermined delimiting condition and a peak of the average power spectrum; and
determining the medium-to-high frequency cutoff point based on a second predetermined delimiting condition and the peak of the average power spectrum.

7. The method according to claim 6, further comprising:
in response to determining the low-to-medium frequency cutoff point and the medium-to-high frequency cutoff point, determining, for each time frame, an average value of power spectra in a plurality of frequency ranges determined by the low-to-medium frequency cutoff point and the medium-to-high frequency cutoff point.

8. The method according to claim 7, wherein the determining reverberation time based on the reverberant audio comprises:
determining a logarithm of the average value of the power spectra in the plurality of frequency ranges and fitting a curve to obtain a decay curve; and
determining the reverberation time based on the decay curve.

9. The method according to claim 2, wherein the determining, by a regression model, a ratio of reverberation to dry sound based on the dry audio and the reverberant audio comprises:
training the regression model based on training audio, the training audio comprising training dry audio and training reverberant audio corresponding to the training dry audio.

10. The method according to claim 9, wherein the training the regression model based on training audio comprises:
determining energy of the training dry audio and energy of the training reverberant audio separately;
determining a ratio of the energy of the training dry audio to the energy of the training reverberant audio;
training the regression model based on a target ratio and the determined ratio; and
adjusting parameters of the regression model based on a mean squared error.

11. The method according to claim 1, wherein the adding reverberation to synthesized dry audio based on the reverberation parameters comprises:
generating synthesized reverberant audio based on the reverberation parameters; and
adding the reverberation to the synthesized dry audio based on a ratio of reverberation to dry sound, the synthesized reverberant audio, and the synthesized dry audio.

12. The method according to claim 11, further comprising:
removing predetermined high-frequency and low-frequency portions of the reverberant audio through a bandpass filter.

13. An electronic device, comprising:
a processor; and
a memory coupled to the processor, wherein the memory has stored therein instructions that, when executed by the processor, cause the electronic device to:
separate reverberant audio based on wet audio, the wet audio comprising dry audio and the reverberant audio corresponding to the dry audio;
determine based on the reverberant audio, reverberation parameters for indicating reverberation effects of the reverberant audio; and
add reverberation to synthesized dry audio based on the reverberation parameters.

14. The device according to claim 13, wherein the instructions causing the processor to determine, based on the reverberant audio, reverberation parameters for indicating reverberation effects of the reverberant audio comprise instructions causing the processor to:
determine early reflection time based on the reverberant audio, the early reflection time indicating a time interval between a direct sound and a reflected sound first arriving at a human ear after a sound is emitted;
determine frequency cutoff points based on the reverberant audio, the frequency cutoff points comprising a low-to-medium frequency cutoff point and a medium-to-high frequency cutoff point; and
determine reverberation time based on the reverberant audio, wherein the reverberation time indicates time required for a sound to decay by a predetermined decibel level from being emitted; and
determine, by a regression model, a ratio of reverberation to dry sound based on the dry audio and the reverberant audio.

15. The device according to claim 14, wherein the instructions causing the processor to determine early reflection time based on the reverberant audio comprise instructions causing the processor to:
determine a peak of cross-correlation between the reverberant audio and reference audio; and
determine the early reflection time based on the peak of cross-correlation.

16. The device according to claim 14, wherein the instructions causing the processor to determine frequency cutoff points based on the reverberant audio comprise instructions causing the processor to:
determine the frequency cutoff points based on the reverberant audio through a short-time Fourier transform.

17. The device according to claim 16, wherein the instructions causing the processor to determine the frequency cutoff points based on the reverberant audio through a short-time Fourier transform comprise instructions causing the processor to:
segment, based on time windows, the reverberant audio into a plurality of reverberant audio segments corresponding to the time windows; and
perform the short-time Fourier transform on each of the reverberant audio segments corresponding to the time windows to obtain a time-frequency domain representation of each frame of a reverberant audio segment corresponding to each of the time windows; and
determine, for the time-frequency domain representation of each frame, a squared modulus of a time-frequency domain representation of each time frame to obtain a power spectrum of the time frame.

18. The device according to claim 17, further comprising instructions causing the processor to:
average power spectra of a plurality of time frames in a frequency dimension to obtain an average power spectrum;
determine the low-to-medium frequency cutoff point based on a first predetermined delimiting condition and a peak of the average power spectrum; and
determine the medium-to-high frequency cutoff point based on a second predetermined delimiting condition and the peak of the average power spectrum.

19. The device according to claim 18, further comprising instructions causing the processor to:
in response to determining the low-to-medium frequency cutoff point and the medium-to-high frequency cutoff point, determine, for each time frame, an average value of power spectra in a plurality of frequency ranges determined by the low-to-medium frequency cutoff point and the medium-to-high frequency cutoff point.

20. A non-transitory computer-readable medium comprising instructions stored thereon which, when executed by a processor, cause the processor to:
separate reverberant audio based on wet audio, the wet audio comprising dry audio and the reverberant audio corresponding to the dry audio;
determine based on the reverberant audio, reverberation parameters for indicating reverberation effects of the reverberant audio; and
add reverberation to synthesized dry audio based on the reverberation parameters.
